(19) United States
(12) Patent Application Publication
(10) Pub. No.: US 2012/0058217 A1
(43) Pub. Date: Mar. 8, 2012

(54) TASTE DETERRENT AND DIET METHOD

(76) Inventor: Heather L. Patty, Scottsdale, AZ (US)

(21) Appl. No.: 12/877,509

(22) Filed: Sep. 8, 2010

(51) Int. Cl. A23L 1/226

(52) U.S. Cl. 426/2; 426/650

(57) ABSTRACT

A diet spray or powder that may be used by a dieter to render a portion of a meal unappetizing. After eating an initial portion of a meal, a dieter may apply a spray or powder to remaining food portions so as to inhibit further eating, and thus reduce total caloric intake and/or inhibit ingestion of additional portions. The use of the product can promote or strengthen a dieter's will-power in the face of surplus, but tempting, food by direct and/or psychological support. A method includes application of the spray or powder to the tempting foodstuff

### BACKGROUND OF THE INVENTION

1. Field of the Invention

The present invention is related generally to diet aids, more particularly, the invention relates to application of food additives and methods for preparing food for restrictive caloric dieting.

2. Description of the Related Art

Obesity has risen to epidemic proportions in the United States of America, wherein approximately one-third of Americans can be classified as obese. The epidemic has major health consequences, as obesity has been linked to many infirmities and illnesses, not the least of which include diabetes, heart disease, and an increased prevalence of cancer. There is a great need for prevention and treatment of overweight and obesity. Population-based strategies that improve social and physical environmental contexts for healthful eating and physical activity are complementary to clinical preventive strategies. Treatment programs for those who are already obese are needed. Enhanced efforts to provide environmental interventions may lead to improved health and to future decreases in the prevalence of obesity.

In order to combat recent waves of obesity, clinical and surgical remedies are available. However, social and psychological methods are still prevalent methods to help control and maintain a healthy body. A multitude of diet strategies and systems are available to the public, and widely used. A strong drawback of many of the mainstream diet programs is the issue of splurging. Dieters tend to cheat on their specific regimen, primarily because many diet strategies rely solely on a person's unaided willpower to overcome appetite forces. This is especially true with diets that restrict or eliminate various favored foodstuffs.

Weight gain (and weight loss) is directly related to total caloric intake; therefore a restricted calorie diet is often used to promote necessary weight loss. Unfortunately, many diet strategies are further frustrated by the market trend toward increasing portion sizes, particularly at restaurants that promote the prevalent “supersizing” phenomenon. Fast food establishments' pricing practices of “value adding”, whereby they offer much larger portions for a few cents more, contributes to the problem. Furthermore, the supersizing phenomenon has spilled over into the home as people tend to serve and consume larger portions than ever before.

Fortunately, we now know that small environmental factors can have a large influence on food consumption. Certain factors may provide a “consumption cue” that implicitly suggests an appropriate amount to eat. For instance, slowing the rate of consumption can significantly alter the total calories consumed. Further, certain temporary psychological associations can halt or slow a rabid eater to allow the hypothalamus (appetite control center) time to regulate blood levels and signal a person to stop eating.

Those persons with more normal diets have also been susceptible to the recent supersizing phenomenon. Some who would otherwise be content with a reasonable portion size are prone to gorge or overeat when the visual/psychological cues of a large portion size overcome their physical and chemical signaling of satiety.

Past methods of appetite control have been moderately successful. Successful laparoscopic surgery and stomach stapling procedures provide an eater with an immediate physical cue to stop eating, as the eater's stomach fills more quickly. However, these methods involve invasive procedures and can be costly.

Others have attempted to alter food with additives that, when ingested, slow caloric ingestion, or work to chemically/physically affect appetite. Still further attempts have been made to sabotage overly-tempting, yet off-limits, food by over-spicing with salts, purgatives, emetics, vesicants, hallucinogens and/or convulsants, for example as taught by DiPaola, et al. in U.S. Pat. No. 4,479,889.

There still exists a great need for an effective convenient non-toxic method of self-actuated appetite control.

### OBJECTS OF THE INVENTION

It is therefore an object of the present invention to provide a non-surgical method for altering a person's caloric intake.

It is another object of the present invention to provide a method for altering food so as to make it less appetizing, so as to inhibit further ingestion.

It is still another object of the present invention to provide a food additive that may be applied to a foodstuff in order to make further eating unappealing to a dieter.

These and other objects of the present invention will become apparent to those skilled in the art as the description thereof proceeds.

### SUMMARY OF THE INVENTION

Accordingly, the present invention provides a method for administration of a formula to a food-stuff in order to effect a self-actuated diet control technique. In one embodiment, a user applies a sufficient amount of formula so as to render the foodstuff temporarily unappetizing and/or sufficiently repellant to the user. The formula may be sprayed over the foodstuff. The formula may consist of a mixture of water and acetic acid. The formula may also include anethol. The formula may also include a peppermint derivative such as menthone, menthol and/or menthyl acetate. The formula may also include other ingredients, such as d-limonene or sodium-chloride (table salt). It is also contemplated that the formula may include coloring agents that can color the formula prior to application, and/or intended to alter the color of the foodstuff upon which it is applied.

In another embodiment, the invention provides a method for assisting proper diet control, by preventing excessive consumption of calories when a dieter is presented with a large portion of foodstuff. A solution may be sprinkled or sprayed upon an unwanted food portion. The dieter, or another user, may apply a sufficient amount of a solution over the foodstuff so as to render in unappetizing by the dieter's taste receptors. The solution may also further render the foodstuff unappetizing by the dieter's smell receptors or by sight.

In another preferred embodiment of the present invention, a method of human actuated self-effective diet control technique is provided in which a sufficient amount of formula is applied to a foodstuff so as to render the foodstuff sufficiently repellent to a human being. The formula may be sprayed onto the foodstuff. The formula should consist of vinegar and peppermint extract. In an alternative the formula may include lemon extract. The formula may include a mixture of lemon extract with vinegar and peppermint extract. The formula may also include salt, anise extract, or an optional food coloring. The formula, may also be a dry formulation with citric acid.

Another embodiment of the present invention provides a diet-suppressant additive solution to be applied to a foodstuff. The solution should include water, at least 2% acetic acid by volume, and at least one bitterant, such as alcohol, anise extract, peppermint, lemon extract, or salt.

In another preferred embodiment of the present invention a method of administration of a human actuated self-effective diet control technique includes applying a sufficient amount of a dry formula so as to render a foodstuff sufficiently repellant to a human being the dry formula contains at least citric acid and may also include sodium chloride, ground black pepper, or cumin. The dry formulation may be intended to be sprinkled upon unwanted food portion(s).

### DETAILED DESCRIPTION OF THE PREFERRED EMBODIMENTS

Although the present invention can be made in many different forms and compositions, the preferred embodiments are herein described. This disclosure exemplifies the principles of the invention, including particular embodiments thereof, but should not be read to limit the broad aspects of the invention only to those illustrated embodiments.

Unless otherwise stated, ingredient amounts are included by volume for liquids and by weight for solids/dry compounds. It is understood that one tablespoon (TBS) is one-half liquid ounce (oz.), one cup is eight oz., one teaspoon (TSP) is approximately one-sixth oz., and one drop is roughly one-six-hundredth of an oz. and may range between 200 and 1,400 drops per ounce.

The present invention includes methods and compositions for allowing an individual to consciously effect some control over their appetite and diet. The present invention includes additives that may be applied to portions of a large meal, preferably after the dieter has consumed an initial portion of such meal, whereby the composition is applied to the left-over amounts that may otherwise be inadvertently ingested and/or lead to over-eating.

A preferred spray liquid solution includes about four ounces of distilled white vinegar in solution, a quarter-teaspoon of anise extract, and a quarter-teaspoon of peppermint extract. The preferred type of vinegar is provided by Food Club, diluted with water to 5% acidity (acetic acid), and distributed by Topco Associates, LLC, 7711 Gross Point Road, Skokie, Ill. 60077. The preferred type of anise extract is provided by McCormick & Co., Inc. of Hunt Valley,

Md., 21031-1100, having a 68% alcohol content with water and oil of anise. The preferred type of peppermint extract is provided by McCormick & Co., Inc., having an 89% alcohol content with oil of peppermint and water.

It is contemplated that one or more of an assortment of food coloring agents may be added to the formulation as needed. The preferred embodiment includes blue food coloring of the type provided by McCormick & Co., Inc. in Federal Food, Drug and Cosmetic Act (FD&C) Blue 1. A coloring agent is preferably included in the composition so as to ensure that visual cues of the discolored foodstuff might further inhibit the dieter from further gorging. Any non-toxic color dye is suitable to effect an unappetizing color change to the product. Toxic coloring agents are useful for this purpose, however they are not preferred as the formula may come into contact with a human and a human mucosal membrane. Those colors least associated with appetizing food are best, and include off-color blue and green or white. Such colors may also simulate visual spoilage. It is preferable that each solution (wet or dry), hereinafter may optionally include food coloring agents. Preferred food coloring agents generally include water and propylene glycol. Preferred colors include FD&C Yellow 5, Red, Blue 1, Red 3. Preferred coloring may be obtained from Assorted Food Color & Egg Dye as distributed by McCormick & Co., Inc. Propylparaben may also be used as a preservative in the coloring agents (preferably at 0.1% in coloring solution) or to preserve solution.

A second preferred embodiment of the present invention includes a liquid formulation of 2.4 ounces of the distilled white vinegar solution, and one-twelfth ounce each of the following: anise extract, peppermint extract and lemon extract. The lemon extract may also be obtained from McCormick & Co., Inc., and is known to have 83% alcohol with water and lemon oil. In addition, a single drop of blue food coloring is optionally preferred.

A third preferred embodiment of the present invention includes a liquid formulation of two ounces of vinegar, one-half ounce of anise extract, one ounce of lemon extract and one-quarter ounce of peppermint extract.

A fourth preferred embodiment of the present invention includes a liquid formulation of two ounces of vinegar, a half-ounce each of anise and lemon extracts, a quarter-ounce of peppermint extract, and a quarter-ounce (by weight) of sodium chloride (salt) as provided via means of kosher salt, as distributed by North American Salt Company of Overland Park, Kans. 66210.

Additional carrier, such as water or vinegar, may be added in addition to these ingredients so as to make application easier. Water may act alone as a solvent; and alcohol may also act alone as a solvent in the absence of water. Furthermore, it is contemplated that a concentrate, having no solvent, may be useful alone or in combination with a separate dilutant, or the concentrate may be intended to be diluted by chemicals present in the foodstuff. In addition, certain known preservatives, preferably non-toxic, may be included in the formulation to maintain its potency over time.

Vinegar is generally obtained by fermenting ethanol into acetic acid. Although the preferred vinegar is distilled white having mostly all acetic acid, citric acid or other acids may be included in addition to, or as replacement for, acetic acid. Distilled white vinegar is commonly used as a cleaning solution, whereas other vinegars may be used more with foods and cooking. Although non-toxic, the use of white vinegar has a more unpleasant flavor, and is thus a preferred choice for the present invention.

Anise extract may be derived from anise (pimpinella anisum) or star anise (illicium verum) and other naturally occurring plants, such as guarana. The anise extract is generally a tincture dissolved with alcohol (ethanol). It is made by extracting the essential oils from anise by an absorption process. The primary extract is the essential oil anethol, an aromatic unsaturated ether compound.

Peppermint extract may be derived as an herbal extract form peppermint (mentha x piperita) or as an oil by pressing or distillation. Menthol, menthone and menthyl esters (such as menthyl acetate) may be present in the essential oil and extract, and a selection of one or many of these constituents roughly defines peppermint derivative. As in anise extract, peppermint oils may be diluted in ethanol. Menthone, or 1-menthone, is a monoterpene and ketone. Menthone is structurally related to menthol (menthol having a secondary alcohol in place of the carbonyl). Menthyl acetate is the acetate ester (a monoterpene) of menthol and contributes about 5% of the volatile oil.

Lemon extract is an essential oil generally diluted in alcohol. However, lemon oil is generally created via a cold-extraction process from lemon zest. Lemon oil can be a natural astringent and antiseptic, and its components may include d-limonene, a hydrocarbon, and cyclic terpene. Lemon oil, and lemon extract, are not generally used for cooking, but rather in cosmetics (astringent) and cleaning products (antiseptic). Lemon oil, in the amounts and concentrations used described hereinafter, is not known to be toxic.

Bitterants are herein defined as additives to any liquid formulation that cause negative response stimulus in a human being. Bitterants may include substances such as those chemicals derived from the lemon as lemon extract, including d-limonene, peppermint derivatives, such as menthol, menthone and menthyl acetate, anise extracts and anethol, sodium chloride in solution, alcohol, and acetic acid. Dry bittering agents can refer to any agent that may be produced in a solid form, and may include citric acid, as well as sodium chloride, ground black pepper and cumin. Bitterants and dry bittering agents should not be read as limited to the exclusive list of agents mentioned herein, but refer to any and all agents that may be added to a solution that alone, or in concert with other ingredients, may in some occasion stimulate a negative response in a human being.

The liquid formulations described above in the preferred embodiments are prepared in the following manner. First, the medium (often vinegar in solution) is used as a base. Other components are added to the base medium one at a time, stirring occasionally. Coloring, or coloring agent(s), are generally added after all other ingredients. In the first preferred embodiment above, the anise extract is added to the base medium before adding the peppermint extract. In the second of the preferred liquid formulations above, lemon extract is added to the base medium after the addition of anise and peppermint. In the third of the preferred embodiments, kosher salt is added after other extracts have been diluted into the solution.

Liquid formulations may be contained, stored and transported in common spray bottles. In tests, the following steps were usual. A meal may be placed before a dieter on a serving platter. After the dieter has commenced eating, and a proper amount of foodstuff has been ingested, the formulation in the bottle may be sprayed on specific foods, or generally over a plate. A single, or multiple sprays generally less than ten, will be adequate to obtain the desired effect.

The spray should be used preferably in the presence of, or by, the dieter. Generally, the extracts are not very stable, and may evaporate and/or break down under excessive heat. Multiple re-application sprays may be needed to reinforce the effect(s) after some time has elapsed. The application will signal to the dieter that further ingestion is not desired.

Although it is not recommended and should not be done, initially, dieters may take a sampling of foodstuffs treated with the present invention. Please note that it is not the intent of the present invention to actually ingest the product.

It is contemplated that the product and method described herein will not be needed at every meal, nor is the spray intended as a crutch for weak dieters. The spray should be used at the occasional meal in which dieter has a history or fear of overeating, i.e. holidays, events, parties, etc. Eventually, the dieter will be able to mentally control appetite, ingestion and portion size with or without diet spray or powder.

In addition, another preferred embodiment of the invention includes the formulation in dry form, such as a powder, granules or other solid form that can be applied to a foodstuff. It is preferred that any such formulation include at least citric acid. A preferred composition of the dry formula can include citric acid, table salt (sodium chloride), pure ground black pepper, and dried cumin. The dry formulation can be prepared by dry-mixing the ingredients in solid form (e.g. grains or powder) by admixing substances according to standard procedures (as in the creation of the liquid formulation). An optional non-toxic substance may be included as a coloring agent. At room temperature, citric acid is a white crystalline powder, and preferably forms a base for addition with equal parts (by volume) of salt, pepper, and cumin. The resulting dry formulation may be contained in a salt-shaker like instrument, whereby, a user can shake an adequate amount of formulation onto a foodstuff. As above, the amount of dry formulation to be used may vary proportionally with the dieter's preferences, tolerances, and/or amount of foodstuff intended to be affected. The dry form has similar properties and effects, and may be used in a similar fashion to the liquid formulation spray as otherwise described herein.

Testing conducted by applicant showed that most respondents responded adversely to citric acid (dry) and/or vinegar (liquid). The dry powder type formulation elicited the strongest response. Furthermore, the dry formula may be easier to apply, and being more portable, easier to use.

The product and method disclosed should not be misused. Anyone subjected to the formula should be well aware of its presence and proper use. The product should not be used on unsuspecting people. Precautions should be taken to ensure that this product is not mistakenly used in preparations or garnishment of food intended to be consumed. Ingestion of excessive amounts of the preferred formulations may lead to possible health hazards.

The diet aide of the present invention is not meant to be ingested. After a dieter or user has decided that further ingestion of any particular item is unwanted, or that a particular food, although tempting, should not be eaten, the formulation may be applied to a foodstuff to assist the dieter's self-control. Once a dieter has decided upon a proper portion of food, the remaining portion can be sectioned off. The formulation can then be applied to the remaining food(s). Application can be food specific, and may even be applied to the entire food portion before any food is ingested, when total abstention is the intended consequence.

Once applied, the product can first act as a visual cue to the dieter to stop eating. The formulations may he intended to alter the coloration or appearance of a foodstuff. The product may also make a food look spoiled. If the visual cues do not work, the formulation may affect the food, as by causing an odor that can deter further eating. If the food is placed in the dieter's mouth, the formulation may cause an immediate disgust by producing unexpected or unwanted taste stimulus. However, the invention is not intended to promote bulimia.

Upon subsequent use of the product, mere cues of the container may affect the same psychological abstention from a foodstuff, so that the product does not actually have to be applied, but only used as a visual cue, thereby triggering the dieter's memory of affected foodstuff and taste. The invention allows dieters to slowly regain conscious control of what they put in their mouths. This extends to a dieter's control over appetite and caloric intake. The product is not meant for continued use, but as an initial cue, or occasional assistance when life factors may affect a dieter's choice of how much to eat.

All of the ingredients disclosed above have been shown to work independently, and in combination, without limit to concentration(s) or total amount used. The formulations are not limited to the ingredients disclosed above. The invention provides a method of assisted restraint support for dieters confronted with large food portions and/or unwanted meal items. Those items intended not to be ingested can be treated with the formulation, thereby deterring eating and/or building psychological associations to limit future eating of particular foods.

The present invention has been described in terms of selected specific embodiments of the invention incorporating details to facilitate the understanding of the principles and use of the invention. Such references herein to specific embodiments and details are not intended to limit the scope of the claims appended hereto. It will be apparent to those skilled in the art that modifications may be made in the embodiments chosen for illustration without departing from the spirit and scope of the invention.

What is claimed is:

1. A method of controlling one's diet, the method comprising the steps of
a) providing a formula comprising water and acetic acid;
b) applying a sufficient amount of the formula to a foodstuff so as to render the foodstuff repellant to a human being.

2. The method of claim 1 wherein the formula further comprises anethol.

3. The method of claim 1 wherein the formula further comprises a peppermint derivative.

4. The method of claim 1 wherein the formula further comprises d-limonene.

5. The method of claim 1 wherein the formula further comprises sodium chloride.

6. The method of claim 1 wherein the formula further comprises at least one coloring agent.

7. The method of claim 1 whereby the applying step is effected by spraying the formula over the foodstuff.

8. A method for assisting proper diet control, by preventing excessive consumption of calories when a dieter is presented with a large portion of foodstuff, comprising the steps of:
a) providing a formula effective to stimulate a human being's taste and wherein the formula can alter the appearance of a foodstuff;
b) applying a sufficient amount of the formula to a foodstuff so as to render the foodstuff repellant to a human being's taste receptors and sight.

9. The method of claim 8 wherein the method includes the further step of providing such formula an ingredient that is unappetizing to the dieter's smell receptors.

10. A human actuated self-effective diet control method, the method comprising the step of:
a) providing a dry formulation;
b) applying a sufficient amount of the formula to a foodstuff so as to render the foodstuff repellant to a human being.

11. The method of claim 10 wherein the dry formula comprises citric acid.

12. The method of claim 10 wherein the dry formula comprises at least one dry bittering agent.

13. The method of claim 10 wherein the formula further comprises food coloring.

14. A diet-suppressant additive formula comprising:
a) water;
b) acetic acid, said acetic acid being at least 2% by volume;
c) at least one bitterant.
